(19) United States
(12) Patent Application Publication
(10) Pub. No.: US 2026/0162503 A1
(43) Pub. Date: Jun. 11, 2026

(54) MULTIPLE PROGRESSIVE JACKPOT AWARDS AND MULTIPLE DRAWS FOR SINGLE PLAY OF A DRAW LOTTERY GAME

(71) Applicant: Brightstar Global Solutions Corporation, Providence, RI (US)

(72) Inventor: Apostolos D. Kallis, Barrington, RI (US)

(21) Appl. No.: 18/976,819

(22) Filed: Dec. 11, 2024

(51) Int. Cl. G07F 17/32

(52) U.S. Cl. CPC G07F 17/329; G07F 17/3258; G07F 17/3269

(57) ABSTRACT

A draw lottery ticket system and method of operating the draw lottery ticket system that provides a draw lottery game with multiple progressive jackpot awards and multiple draws for a single play of the draw lottery game.

### BACKGROUND

The present disclosure relates to multiple progressive jackpot awards and multiple draws for a single play of a draw lottery game.

Draw lottery ticket systems may enable players to purchase draw lottery tickets for plays of draw lottery games. Certain draw lottery ticket systems may provide a static jackpot award as the top award for the play of the draw lottery game. Certain draw lottery ticket systems may provide a progressive jackpot award as the top award for the play of the draw lottery game.

### BRIEF SUMMARY

In various embodiments, the present disclosure relates to a draw lottery ticket system including a processor and a memory device that stores a plurality of instructions, which when executed by the processor, cause the processor to grow a first progressive jackpot award for a draw lottery game based on purchases of draw lottery tickets for the draw lottery game. The plurality of instructions, when executed by the processor, further cause the processor to: responsive to determining that the first progressive jackpot award is not won and reaches a first upper limit amount: set that first progressive jackpot award at that first upper limit amount, create a second progressive jackpot award for the draw lottery game, and grow the second progressive jackpot award based on subsequent purchases of the draw lottery tickets for that draw lottery game. The plurality of instructions, when executed by the processor, further cause the processor to: responsive to determining that the second progressive jackpot award is not won and reaches a second upper limit amount: set that second progressive jackpot award at that second upper limit amount, create a third progressive jackpot award for the draw lottery game, and grow the third progressive jackpot award based on subsequent purchases of the draw lottery tickets for that draw lottery game.

In various other embodiments, the present disclosure relates to a draw lottery ticket system including a processor and a memory device that stores a plurality of instructions, which when executed by the processor, cause the processor to grow a first progressive jackpot award for a draw lottery game based on purchases of draw lottery tickets for the draw lottery game. The plurality of instructions, when executed by the processor, further cause the processor to: responsive to determining that the first progressive jackpot award is not won and reaches a first upper limit amount: set that first progressive jackpot award at that first upper limit amount, create a second progressive jackpot award for the draw lottery game, and grow the second progressive jackpot award based on subsequent purchases of the draw lottery tickets for that draw lottery game. The plurality of instructions, when executed by the processor, further cause the processor to: for the first progressive jackpot award for a single play of the draw lottery game: provide one drawing for the single play of the draw lottery game, based on that first drawing, determine if any of the draw lottery tickets for that single play of the draw lottery game wins the first progressive jackpot award, based on that first drawing, determine if any of the draw lottery tickets for that single play of the draw lottery game wins any secondary awards associated with the first progressive jackpot award, if one of the draw lottery tickets wins the first progressive jackpot award, cause that first progressive jackpot award to be available to be provided to a holder of that winning draw lottery ticket upon redemption of that winning draw lottery ticket, if none of the draw lottery tickets wins the first progressive jackpot award, roll over that first progressive jackpot award for a next play of the draw lottery game, and if one of the draw lottery tickets wins any of secondary awards, cause that secondary award to be available to be provided to a holder of that winning draw lottery ticket upon redemption of that winning draw lottery ticket.

In various other embodiments, the present disclosure relates to a draw lottery ticket system including a processor and a memory device that stores a plurality of instructions, which when executed by the processor, cause the processor to grow a first progressive jackpot award for a draw lottery game based on purchases of draw lottery tickets for the draw lottery game. The plurality of instructions, when executed by the processor, further cause the processor to: after determining that the first progressive jackpot award has not been won and has reached a first upper limit amount: set that first progressive jackpot award at that first upper limit amount, create a second progressive jackpot award for the draw lottery game, and grow the second progressive jackpot award based on subsequent purchases of the draw lottery tickets for that draw lottery game. The plurality of instructions, when executed by the processor, further cause the processor to: after determining that the second progressive jackpot award has not been won and has reached a second upper limit amount: set that second progressive jackpot award at that second upper limit amount, create a third progressive jackpot award for the draw lottery game, and grow the third progressive jackpot award based on subsequent purchases of the draw lottery tickets for that draw lottery game. The plurality of instructions, when executed by the processor, further cause the processor to: for the first progressive jackpot award for a single play of the draw lottery game: provide a first drawing for the single play of the draw lottery game, based on that first drawing, determine if any of the draw lottery tickets for that single play of the draw lottery game wins the first progressive jackpot award, and if one of the draw lottery tickets wins the first progressive jackpot award, cause that first progressive jackpot award to be available to be provided to a holder of that winning draw lottery ticket upon redemption of that winning draw lottery ticket. The plurality of instructions, when executed by the processor, further cause the processor to: for the second progressive jackpot award for the single play of the draw lottery game: provide a second drawing for the single play of the draw lottery game, based on that second drawing, determine if any of the draw lottery tickets for that single play of the draw lottery game wins the second progressive jackpot award, and if one of the draw lottery tickets wins the second progressive jackpot award, cause that second progressive jackpot award to be available to be provided to a holder of that winning draw lottery ticket upon redemption of that winning draw lottery ticket. The plurality of instructions, when executed by the processor, further cause the processor to: for the third progressive jackpot award for the single play of the draw lottery game: provide a third drawing for the single play of the draw lottery game, based on that third drawing, determine if any of the draw lottery tickets for that single play of the draw lottery game wins the third progressive jackpot award, and if one of the draw lottery tickets wins the third progressive jackpot award, cause that third progressive jackpot award to be available to be provided to a holder of that winning draw lottery ticket upon redemption of that winning draw lottery ticket.

Additional features are described in, and will be apparent from, the following Detailed Description and the figures.

### BRIEF DESCRIPTION OF THE SEVERAL VIEWS OF THE DRAWINGS

FIG. 1 is a front view of an example known draw lottery ticket for a draw lottery game.

FIG. 2 is a flowchart of an example method for operating a draw lottery ticket system that provides a draw lottery game with multiple progressive jackpot awards and multiple draws for a single play of the draw lottery game in accordance with one example embodiment of the present disclosure.

FIGS. 3A, 3B, and 3C are front views of first, second, and third example draw lottery tickets for a single play of a draw lottery game that includes multiple progressive jackpot awards and multiple draws in accordance with one example embodiment of the present disclosure.

FIG. 4 is a diagrammatic view of an example draw lottery ticket system in accordance with one embodiment of the present disclosure.

### DETAILED DESCRIPTION

In various embodiments, the present disclosure relates to draw lottery ticket systems and methods of operating such draw lottery ticket systems that provide a draw lottery game with multiple progressive jackpot awards and multiple draws for a single play of the draw lottery game.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. Even though a draw lottery ticket may have multiple sets of player numbers, each set of player numbers for each play of a draw lottery game is considered a separate play of that draw lottery game. For simplicity, the present disclosure uses a draw lottery ticket with a single set of player numbers for a single play of a single draw lottery game as an example, but it should be appreciated that the draw lottery ticket system of the present disclosure can be employed for purchasing and redeeming such various other draw lottery tickets.

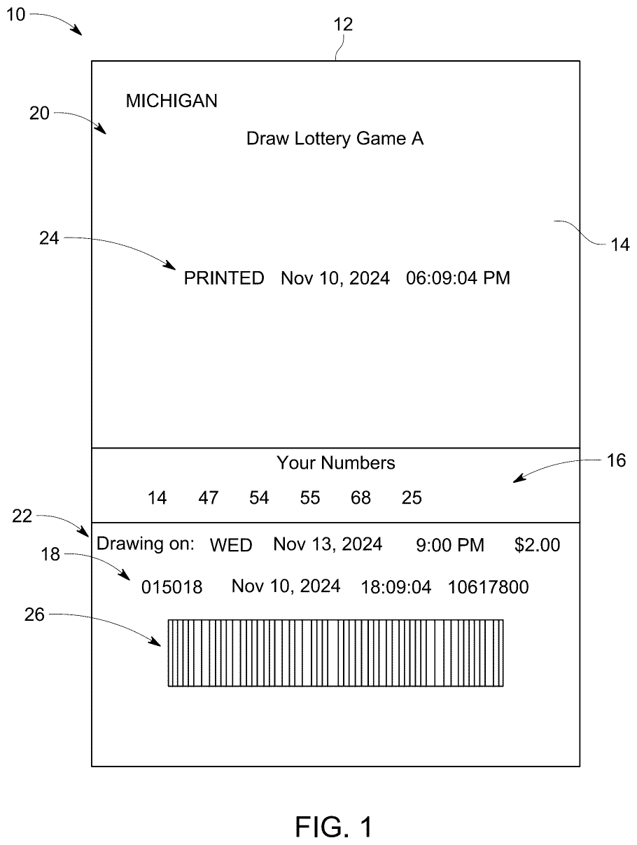

An example physical draw lottery ticket 10 is shown in FIG. 1. This example draw lottery ticket 10 is for a single play of a single draw lottery game and includes: (1) a ticket substrate 12; (2) a front surface 14 of the ticket substrate 12; (3) draw lottery ticket information for the single play of the single draw lottery game printed on the front surface 14 of the ticket substrate 12; and (4) a back surface (not shown) of the ticket substrate 12. This example draw lottery ticket 10 is for a single play of a single draw lottery game scheduled to take place on Nov. 10, 2024, at 9:00 p.m. and includes a single set of player numbers 16 for the single play of the draw lottery game. The lottery ticket information in this example includes the player numbers 16, a draw lottery ticket identifier 18 that uniquely identifies the draw lottery ticket 10, a draw game identifier 20 that uniquely identifies the draw lottery game, a draw date and time 22 for the play of the draw lottery game, and a print date 24 on which this draw lottery ticket 10 was printed. The lottery ticket information can include text, a draw lottery ticket number which can be the ticket identifier 18, a draw lottery ticket barcode 26, and for other lottery ticket information that is in either or both human readable and machine readable forms. The lottery ticket barcode 26 is configured to be scanned by a barcode reading device to enable identification and redemption of the draw lottery ticket 10 if the draw lottery ticket 10 is a winning draw lottery ticket.

Additionally, for a better understanding of the present disclosure, various known systems and methods employed for purchasing draw lottery tickets are also now described.

In a first known draw lottery ticket system and method for purchasing a draw lottery ticket for a draw lottery game in person, a player selects the player numbers for the draw lottery ticket and the player fills out a paper play slip with the player's selected numbers. The player hands that play slip to an operator of a lottery terminal and the operator uses a lottery terminal including a contact image sensor (CIS) reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers and other information described above. The lottery terminal and specifically the terminal application causes a lottery ticket printer to print out the draw lottery ticket. The lottery ticket printer can be part of the lottery terminal or separate from but connected to the lottery terminal. The operator of the lottery terminal also collects the payment for the draw lottery ticket and provides the printed draw lottery ticket to the player. The lottery terminal can include the CIS reader and the lottery ticket printer in one cabinet. The CIS reader and/or the lottery ticket printer can be separate from the lottery terminal cabinet and connected to the lottery terminal by suitable wires.

In one variation of this known method for purchasing a draw lottery ticket for a draw lottery game in person, a player does not select the player numbers for the draw lottery ticket and the player marks a paper play slip with an indication of a requested quick pick for the player numbers. The player hands that play slip to an operator of a lottery terminal and the operator uses a lottery terminal including a CIS reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers and other information described above. In this case, the lottery terminal randomly generates the player numbers. The lottery terminal causes a lottery ticket printer to print out the draw lottery ticket.

In another variation of this method for purchasing a draw lottery ticket for a draw lottery game in person, a player does not fill out a paper play slip with the player's selected numbers, but rather the player tells the operator of a lottery terminal that the player wants to purchase a draw lottery ticket using a quick pick for a draw lottery game and the operator inputs that request into the lottery terminal (via an operator interface of the lottery terminal). The lottery terminal randomly determines the player numbers for the player's lottery ticket for the play of the lottery game and uses those numbers to create a draw lottery ticket. The lottery terminal then causes a lottery ticket printer to print out the draw lottery ticket.

In another variation of this method for purchasing a draw lottery ticket for a draw lottery game in person, a player uses a suitable application on a player's computer such as a player smartphone to fill out an electronic play slip displayed by the player's smartphone with the player's selected numbers for the draw lottery game or a quick pick. The application on the player's smartphone creates a barcode displayable by the display device of the player mobile electronic device. The player causes their mobile electronic device to display the barcode such that a CIS reader of a lottery terminal having a barcode scanner scans the barcode and creates player slip scan data representing the player numbers or the quick pick for the play of the draw lottery game. The CIS reader sends the player slip scan data to a terminal application of the lottery terminal, and the terminal application uses that player slip scan data to create a draw lottery ticket including the player numbers (respectively either selected by the player or randomly selected by the lottery terminal). The lottery terminal causes a lottery ticket printer to print out the draw lottery ticket.

In each of these variations, the lottery terminal sends data regarding each purchased draw lottery ticket for each draw lottery game to a central lottery server of the draw lottery ticket system. This draw lottery ticket data includes: (1) the player numbers for the draw lottery ticket; (2) the draw lottery ticket identifier that uniquely identifies the draw lottery ticket; (3) the draw game identifier that identifies the draw lottery game; (4) the draw date for the play of the draw lottery game; (5) a print date on which the draw lottery ticket was printed; and (6) barcode related data for the draw lottery ticket.

Such draw lottery games often include a single progressive jackpot award as the top award. This single progressive jackpot award for the draw lottery game can grow incrementally based on the sales of the draw lottery tickets for plays of that draw lottery game. A percentage of sales of the draw lottery tickets for the plays of the draw lottery game are ear-marked to fund the progressive jackpot award for that draw lottery game and increases to that progressive jackpot award.

If the progressive jackpot award is not won for a play of the draw lottery game, the progressive jackpot award is rolled over to the next play of that draw lottery game. This can happen multiple times such that the progressive jackpot award can grow to a substantially large amount of such as hundreds of thousands of dollars, millions of dollars, hundreds of millions of dollars, and in some known instances, to over a billion dollars (all depending on the award structure of the draw lottery game). As indicated above, for each set of numbers of a draw lottery ticket (which is considered a single play of that draw lottery game), the player has one chance to match of the player numbers with the drawn numbers for that play of the draw lottery game, and thus one chance to win the progressive jackpot award (regardless of how large the progressive jackpot award becomes).

In various embodiments, the present disclosure relates to draw lottery ticket systems and methods of operating draw lottery ticket systems that provide multiple progressive jackpot awards and multiple draws for each of one or more single plays of the draw lottery game.

In various embodiments, the present disclosure relates to a draw lottery ticket system that tracks the growth of a first progressive jackpot award for a draw lottery game. If that first progressive jackpot award is not won and also reaches a first upper limit amount, the draw lottery ticket system: (1) sets that first progressive jackpot award at that first upper limit amount; (2) creates a second progressive jackpot award for the draw lottery game; and (3) starts growing the second progressive jackpot award based on further sales of the draw lottery tickets for that draw lottery game. If the second first progressive jackpot award is not won and reaches a second upper limit amount, the draw lottery ticket system: (1) sets the second progressive jackpot award at that second upper limit amount; (2) creates a third progressive jackpot award for the draw lottery game; and (3) starts growing that third progressive jackpot award based on further sales of the draw lottery tickets for that draw lottery game.

In various embodiments, this process of creating additional progressive jackpot awards can continue one or more times until all of such progressive jackpot awards are won.

In various embodiments, this process of creating additional progressive jackpot awards that can continue one or more times until all of such progressive jackpot awards are won can be limited to a certain quantity of such progressive jackpot awards.

In various embodiments, when only the first progressive jackpot award exists for a play of the draw lottery game, the draw lottery ticket system provides one drawing for the play of the draw lottery game, and determines if any of the draw lottery tickets for that play of the draw lottery game win the first progressive jackpot award or any secondary awards. If one of the draw lottery tickets wins the first progressive jackpot award, then the draw lottery ticket system causes that first progressive jackpot award to be available to be provided to the holder of that winning draw lottery ticket upon redemption of that winning draw lottery ticket. If none of the draw lottery tickets win the first progressive jackpot award, then the draw lottery ticket system rolls over that first progressive jackpot award for the next play of the draw lottery game.

In various embodiments, when the first progressive jackpot award exists and the second progressive jackpot award exists, the draw lottery ticket system provides: (1) a first drawing for the play of the draw lottery game, and determines if any of the draw lottery tickets win the first progressive jackpot award and any secondary awards; and (2) a second drawing for that same play of the draw lottery game, and determines if any of the draw lottery tickets win the second progressive jackpot award (but no secondary awards associated with that second progressive jackpot award). If one of the draw lottery tickets wins the first progressive jackpot award based on the first drawing, then the draw lottery ticket system causes that first progressive jackpot award to be available provided to the holder of that draw lottery ticket upon redemption of that winning draw lottery ticket. If none of the draw lottery tickets win the first progressive jackpot award, then the draw lottery ticket system rolls over that first progressive jackpot award for the next play of the draw lottery game. If one of the draw lottery tickets wins the second progressive jackpot award based on the second drawing, then the draw lottery ticket system causes that second progressive jackpot award to be available to be provided to the holder of that draw lottery ticket upon redemption of that winning draw lottery ticket. If none of the draw lottery tickets win the second progressive jackpot award, then the draw lottery ticket system rolls over that second progressive jackpot award for the next play of the draw lottery game. In these embodiments, the second drawing can only result in the win of the second progressive jackpot award. In alternative embodiments: (1) the first drawing for the play of the draw lottery game can result in a win of the first progressive jackpot award but no secondary awards; and (2) the second drawing for the play of the draw lottery game can result in the win of the second progressive jackpot award and one or more secondary awards. In these alternative embodiments, the first drawing can only result in the win of the first progressive jackpot award.

In various embodiments, when the first progressive jackpot award exists, the second progressive jackpot award exists, and the third progressive jackpot award exists, the draw lottery ticket system provides: (1) a first drawing for the play of the draw lottery game, determines if any of the draw lottery tickets win the first progressive jackpot award and any secondary awards; (2) a second drawing for that same play of the draw lottery game, and determines if any of the draw lottery tickets win the second progressive jackpot award (but no secondary awards); and (3) a third drawing for that same play of the draw lottery game, and determines if any of the draw lottery tickets win the third progressive jackpot award (but no secondary awards). If one of the draw lottery tickets wins the first progressive jackpot award based on the first drawing, then the draw lottery ticket system causes that first progressive jackpot award to be available to be provided to the holder of that draw lottery ticket upon redemption of that winning draw lottery ticket. If none of the draw lottery tickets win the first progressive jackpot award, then the draw lottery ticket system rolls over that first progressive jackpot award for the next play of the draw lottery game. If one of the draw lottery tickets wins the second progressive jackpot award based on the second drawing, then the draw lottery ticket system causes that second progressive jackpot award to be available to be provided to the holder of that draw lottery ticket upon redemption of that winning draw lottery ticket. If none of the draw lottery tickets win the second progressive jackpot award, then the draw lottery ticket system rolls over that second progressive jackpot award for the next play of the draw lottery game. If one of the draw lottery tickets wins the third progressive jackpot award based on the third drawing, then the draw lottery ticket system causes that third progressive jackpot award to be available to be provided to the holder of that draw lottery ticket upon redemption of that winning draw lottery ticket. If none of the draw lottery tickets win the third progressive jackpot award, then the draw lottery ticket system rolls over that third progressive jackpot award for the next play of the draw lottery game. In these embodiments, the second drawing can only result in the win of the second progressive jackpot award and the third drawing can only result in the win of the third progressive jackpot award. In alternative embodiments: (1) the first drawing for the play of the draw lottery game can result in a win of the first progressive jackpot award but no secondary awards; (2) the second drawing for the play of the draw lottery game can result in the win of the second progressive jackpot award and secondary awards; and (3) the third drawing for the play of the draw lottery game can result in the win of the third progressive jackpot award and no secondary awards. In further alternative embodiments: (1) the first drawing for the play of the draw lottery game can result in a win of the first progressive jackpot award but no secondary awards; (2) the second drawing for the play of the draw lottery game can result in the win of the second progressive jackpot award and no secondary awards; and (3) the third drawing for the play of the draw lottery game can result in the win of the third progressive jackpot award and any secondary awards.

In various embodiments, the draw lottery ticket system can continue adding progressive jackpot awards in this manner, or can alternatively limit the quantity of additional progressive jackpot awards.

In these embodiments, the last created progressive jackpot award continues to grow based on ticket sales for the draw lottery game.

In these embodiments, with a single draw lottery ticket, the player has a separate and independent chances of winning each of the existing progressive jackpot awards at the time of the draw for a single play of the lottery draw game. The quantity of additional draws for the single play of the draw lottery game is thus based on the quantity of additional progressive jackpot awards created for that draw lottery game. This gives each of the players of the single play of the draw lottery game multiple separate opportunities to win each one of the existing respective progressive jackpot awards (instead of the traditional single opportunity to win one jackpot) regardless of when the player purchased their draw lottery ticket for that single play of the draw lottery game. In other words, these opportunities are not based on when the player purchases the draw lottery ticket or the existing progressive jackpot awards at the time of purchase.

In various embodiments, each additional draw for the single play of the draw lottery game does not require any extra player wager or purchase.

In various embodiments, the respective upper limit amounts for each of the progressive jackpot awards for a draw lottery game is the same.

In various embodiments, the respective upper limit amounts for two or more or each of the progressive jackpot awards for a draw lottery game is different.

In various embodiments, the respective upper limit amounts can be set reasonably high (such as at $100,000,000) such that each separate progressive jackpot award is still very attractive to players.

Using the above example, and a progressive jackpot award that reaches $450,000,000 in a known draw lottery ticket system, the draw lottery ticket system of present disclosure can instead provide four progressive jackpots awards that are each of $100,000,000 and a fifth progressive jackpot of $50,000,000, and thus five total respective draws for a single play of the draw lottery game.

In various embodiments, the draw lottery ticket system configures and initiates a new draw lottery game including: (1) determining a paytable for the draw lottery game including an initial progressive jackpot award and one or more secondary awards; (2) a drawing schedule (such as dates and times) for each play of the draw lottery game; and (3) suitable rules for the draw lottery game.

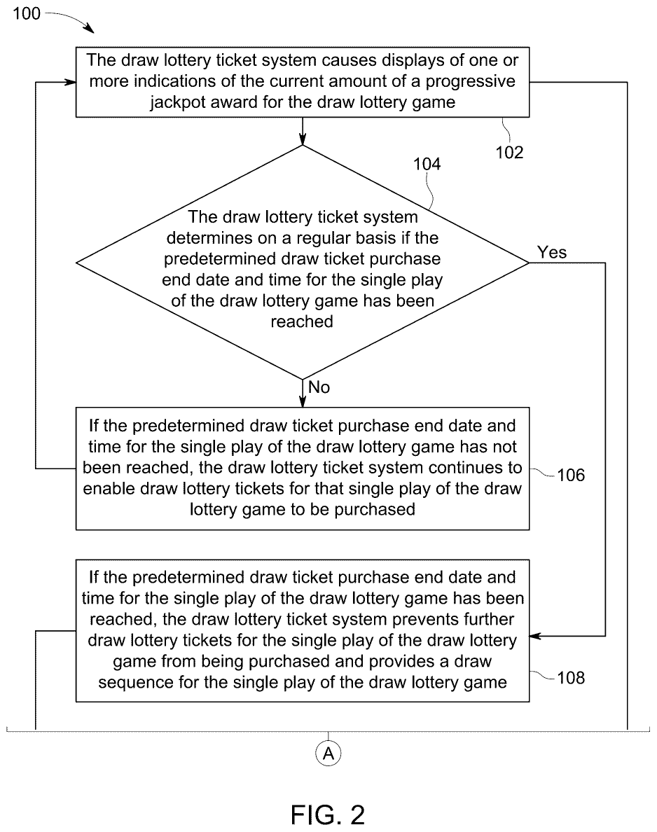

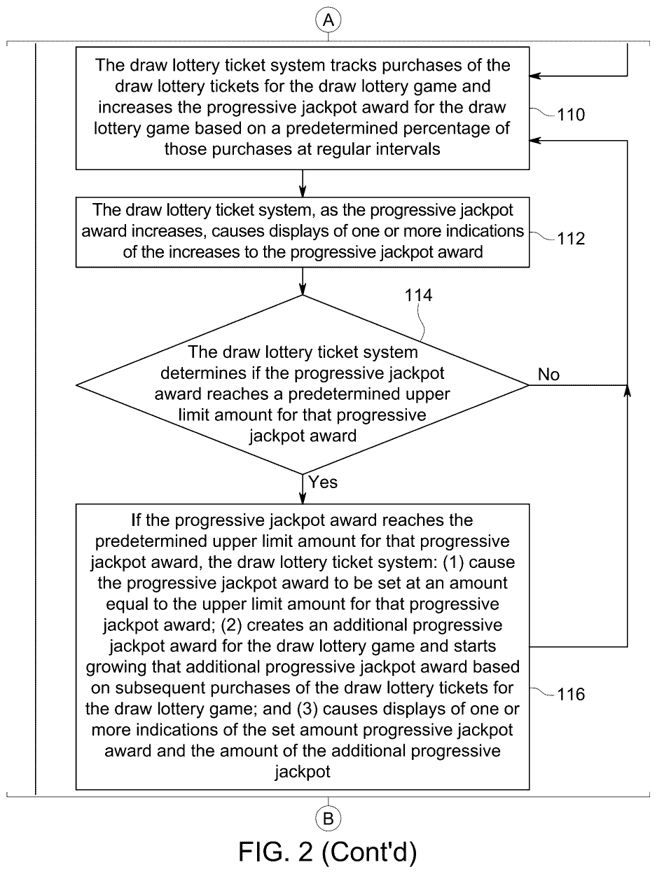

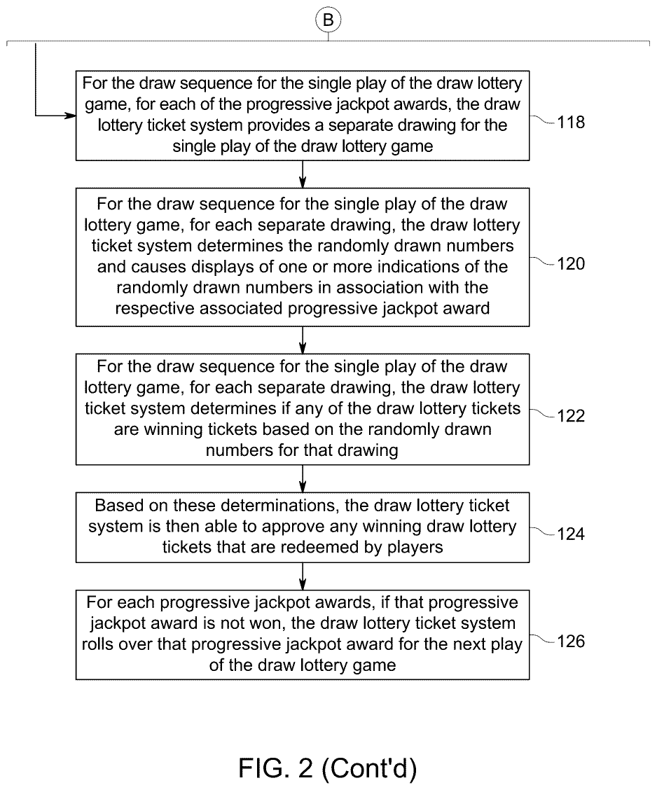

Thereafter, in various embodiments, for each single play of the draw lottery game provided by the draw lottery ticket system, the draw lottery ticket system performs the method 100 shown in FIG. 2.

FIG. 2 is thus a flowchart of an example method 100 of operating the draw lottery ticket system of the present disclosure for each single play of the draw lottery game. In various embodiments, the method is represented by a set of instructions stored in one or more memories and executed by one or more processors. Although the method is described with reference to the flowchart shown in FIG. 2, many other processes of performing the acts associated with this illustrated method may be employed. For example, the order of certain of the illustrated blocks or diamonds may be changed, certain of the illustrated blocks or diamonds may be optional, or certain of the illustrated blocks or diamonds may not be employed.

The draw lottery ticket system causes displays of one or more indications of the current amount of a progressive jackpot award for the draw lottery game, as indicated by block 102.

The draw lottery ticket system determines on a regular basis if the predetermined draw ticket purchase end date and time for the single play of the draw lottery game has been reached, as indicated by diamond 104.

If the predetermined draw ticket purchase end date and time for the single play of the draw lottery game has not been reached, the draw lottery ticket system continues to enable draw lottery tickets for that single play of the draw lottery game to be purchased and provides a draw sequence for the single play of the draw lottery game, as indicated by block 106.

If the predetermined draw ticket purchase end date and time for the single play of the draw lottery game has been reached, the draw lottery ticket system prevents further draw lottery tickets for the single play of the draw lottery game from being purchased, as indicated by block 108.

If the predetermined draw ticket purchase date and time for the single play of the draw lottery game has been reached, the draw lottery ticket system causes a draw sequence for the single play of the draw lottery game, as indicated by block 118.

The draw lottery ticket system tracks purchases of the draw lottery tickets for the draw lottery game and increases the progressive jackpot award for the draw lottery game based on a predetermined percentage of those purchases at regular intervals, as indicated by block 110.

The draw lottery ticket system, as the progressive jackpot award increases, causes displays of one or more indications of the increases to the progressive jackpot award, as indicated by block 112.

The draw lottery ticket system determines if the progressive jackpot award reaches a predetermined upper limit amount for that progressive jackpot award, as indicated by diamond 114.

If the progressive jackpot award has not reached the predetermined upper limit amount for that progressive jackpot award, the draw lottery ticket system returns to block 110.

If the progressive jackpot award reaches the predetermined upper limit amount for that progressive jackpot award, the draw lottery ticket system: (1) cause the progressive jackpot award to be set at an amount equal to the upper limit amount for that progressive jackpot award; (2) creates an additional progressive jackpot award for the draw lottery game and starts growing that additional progressive jackpot award based on subsequent purchases of the draw lottery tickets for the draw lottery game; and (3) causes displays of one or more indications of the set amount progressive jackpot award and the amount of the additional progressive jackpot, as indicated by block 116. The draw lottery system also returns to block 110. This process of setting the amounts of the progressive jackpot award at the upper limit amount and creating additional progressive jackpot awards can continue one or more times until all of such progressive jackpot awards are won.

For the draw sequence for the single play of the draw lottery game, for each of the progressive jackpot awards including additional progressive jackpot awards, the draw lottery ticket system provides a separate drawing for the single play of the draw lottery game, as indicated by block 118.

For the draw sequence for the single play of the draw lottery game, for each separate drawing, the draw lottery ticket system determines the randomly drawn numbers and causes displays of one or more indications of the randomly drawn numbers in association with the respective associated progressive jackpot award, as indicated by block 120.

For the draw sequence for the single play of the draw lottery game, for each separate drawing, the draw lottery ticket system determines if any of the draw lottery tickets are winning tickets based on the randomly drawn numbers for that drawing, as indicated by block 122.

This includes for one of the progressive jackpot awards, the draw lottery ticket system determining if any of the draw lottery tickets for the play of the draw lottery win the respective progressive jackpot award associated with that drawing or any secondary awards associated with the drawing.

This includes for each of the other progressive jackpot awards, the draw lottery ticket system determining if any of the draw lottery tickets for the play of the draw lottery win the respective progressive jackpot award associated with that drawing.

Based on these determinations, the draw lottery ticket system is then able to approve any winning draw lottery tickets that are redeemed by players, as indicated by block 124.

For each progressive jackpot awards, if that progressive jackpot award is not won, the draw lottery ticket system rolls over that progressive jackpot award for the next play of the draw lottery game as indicated by block 126.

In these embodiments, with a single draw lottery ticket for a single play of the draw lottery game, the player has a separate and independent chance of winning each respective progressive jackpot award based on a separate drawing. The quantity of additional drawings are thus based on the quantity of additional progressive jackpot awards created for the draw lottery game.

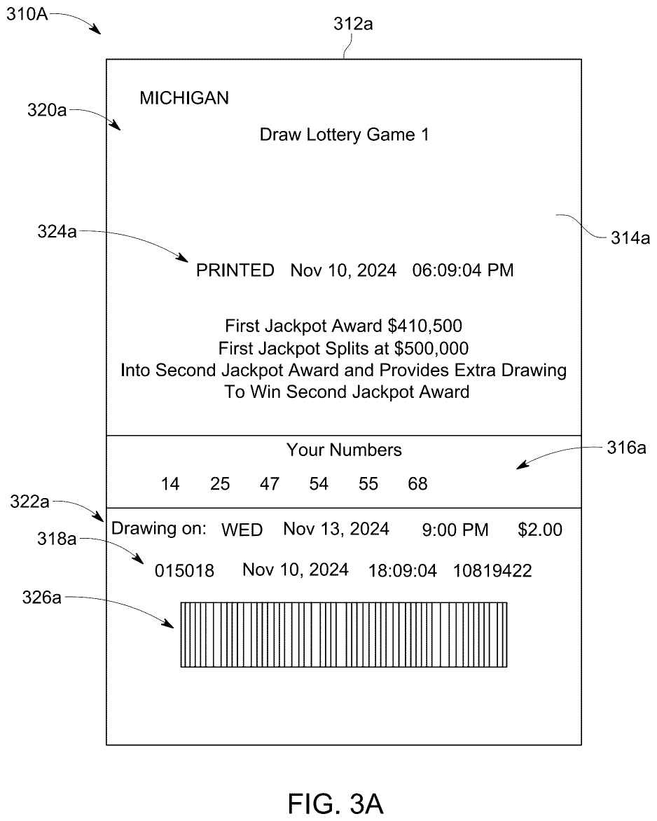

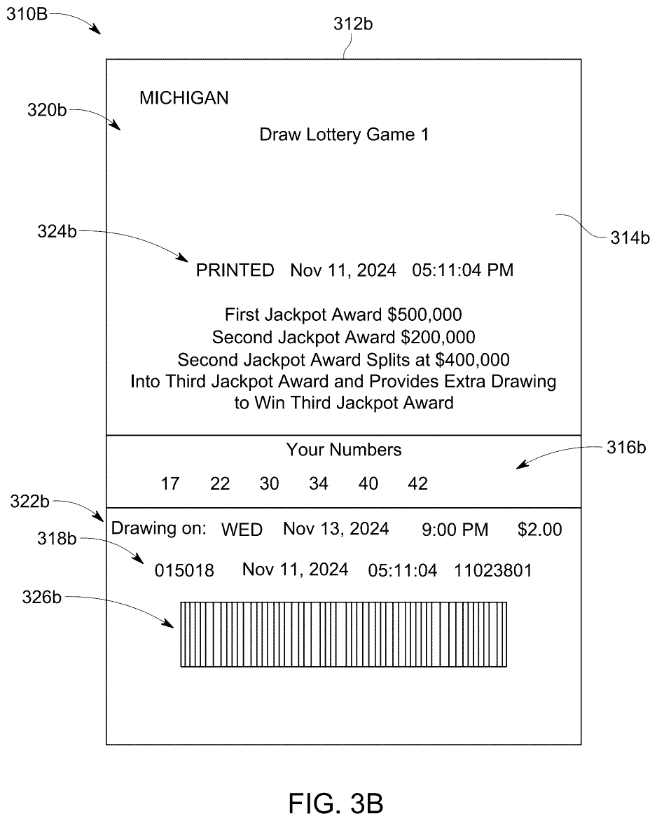

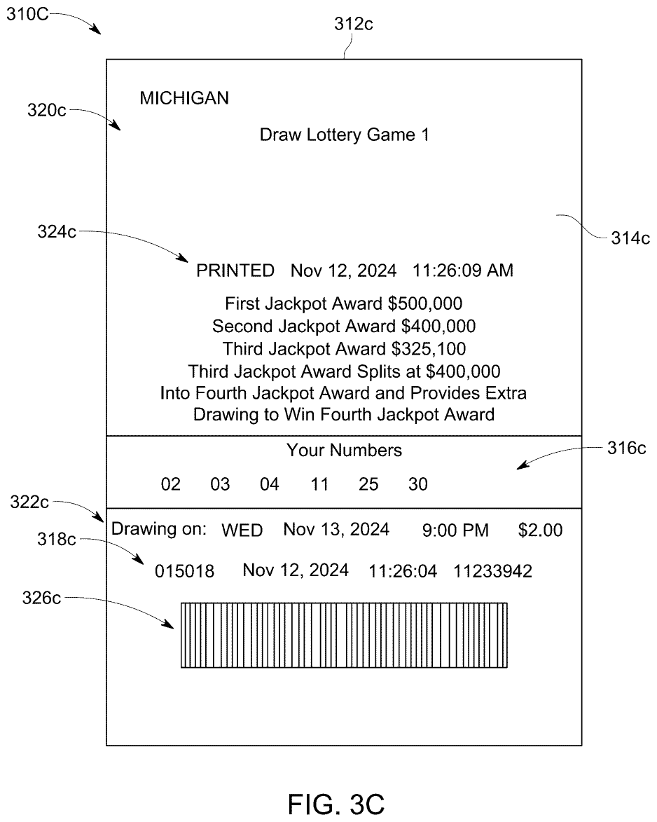

FIGS. 3A, 3B, and 3C illustrate three example draw lottery tickets 310A, 310B, and 310C for a single play of a draw lottery game provided by a draw lottery ticket system, and wherein the draw lottery game includes multiple progressive jackpot awards at the time of the drawing for the single play of the draw lottery game in accordance with one example embodiment of the present disclosure.

The lottery ticket 310A is for a single play of a draw lottery game and includes: (1) a ticket substrate 312a; (2) a front surface 314a of the ticket substrate 312a; (3) lottery ticket information for the single play of the draw lottery game printed on the front surface 314a of the ticket substrate 312a; and (4) a back surface (not shown) of the ticket substrate 312a. This example draw lottery ticket 310A is for the single play of the draw lottery game that is scheduled to take place on Nov. 10, 2024, and includes a single set of player numbers 316a for the single play of the draw lottery game. The lottery ticket information in this example includes player numbers 316a, a draw lottery ticket identifier 318a (such as barcode 336a) that uniquely identifies the draw lottery ticket 310A, a draw game identifier 320a that identifies the draw lottery game, a draw date 322a for the single play of the draw lottery game, and a print date 324a on which the draw lottery ticket 310A was printed. The lottery ticket information can be in either or both human readable and machine readable forms. The lottery ticket barcode 326a is configured to be scanned by a barcode reading device to enable identification and redemption of the draw lottery ticket 310A if the draw lottery ticket 310A is a winning draw lottery ticket.

As indicated on the first draw lottery ticket 310A, at the time of purchase of that draw lottery ticket 310A, the draw lottery ticket system was only maintaining a first progressive jackpot award that was at $410,000. The first draw lottery ticket 310A also indicates that the first progressive jackpot award has an upper limit amount of $500,000, and when the draw lottery ticket system determines that the first progressive jackpot award reaches that upper limit amount, the draw lottery ticket system will set the first progressive jackpot award at that upper limit amount, create a second progressive jackpot award, and will provide an additional drawing for the single play of the draw lottery game for that second progressive jackpot award.

The lottery ticket 310B is for the same single play of the draw lottery game as lottery ticket 310A and includes: (1) a ticket substrate 312b; (2) a front surface 314b of the ticket substrate 312b; (3) lottery ticket information for the single play of the draw lottery game) printed on the front surface 314b of the ticket substrate 312b; and (4) a back surface (not shown) of the ticket substrate 312b. This example draw lottery ticket 310B is for the same single play of the draw lottery game scheduled to take place on Nov. 10, 2024, and includes a single set of player numbers 316b for the single play of the draw lottery game. The lottery ticket information in this example includes the player numbers 316b, a draw lottery ticket identifier 318b (such as barcode 336b) that uniquely identifies the draw lottery ticket 310B, a draw game identifier 320b that identifies the draw lottery game, a draw date 322b for the single play of the draw lottery game, and a print date 324b on which the draw lottery ticket 310B was printed. The lottery ticket information can be in either or both human readable and machine readable forms. The lottery ticket barcode 326b is configured to be scanned by a barcode reading device to enable identification and redemption of the draw lottery ticket 310B if the draw lottery ticket 310B is a winning draw lottery ticket.

As indicated on the second draw lottery ticket 310B, at the time of purchase of that draw lottery ticket 310B, the draw lottery ticket system has set the first progressive jackpot award at the upper limit amount of $500,000, and has created and was maintaining a second progressive jackpot award that was at $200,000 at the time of purchase of the second draw lottery ticket 310B. The second draw lottery ticket 310B also indicates that the second progressive jackpot award has an upper limit amount of $400,000, and when the draw lottery ticket system determines that the second progressive jackpot award reaches that upper limit amount, the draw lottery ticket system will set the second progressive jackpot award at that upper limit amount, create a third progressive jackpot award, and provide an additional drawing for the single play of the draw lottery game for that third progressive jackpot award.

The lottery ticket 310C is for the same single play of the draw lottery game as lottery tickets 310A and 310B and includes: (1) a ticket substrate 312c; (2) a front surface 314c of the ticket substrate 312c; (3) lottery ticket information for the single play of the draw lottery game printed on the front surface 314c of the ticket substrate 312c; and (4) a back surface (not shown) of the ticket substrate 312c. This example draw lottery ticket 310C is for the same single play of the draw lottery game scheduled to take place on Nov. 10, 2024, and includes a single set of player numbers 316c for the single play of the draw lottery game. The lottery ticket information in this example (such as barcode 336C) identifies the draw lottery ticket 310C, a draw game identifier 320c that identifies the draw lottery game, a draw date 322c for the single play of the draw lottery game, and a print date 324c on which the draw lottery ticket 310C was printed. The lottery ticket information can barcode 336c, and other lottery ticket information that is in either or both human readable and machine readable forms. The lottery ticket barcode 326c is configured to be scanned by a barcode reading device to enable identification and redemption of the draw lottery ticket 310C if the draw lottery ticket 310C is a winning draw lottery ticket.

As indicated on the third draw lottery ticket 310C, at the time of purchase of that draw lottery ticket 310C, the draw lottery ticket system has set the first progressive jackpot award at the $500,000 upper limit amount for that progressive jackpot award, has set the second progressive jackpot award at the $400,000 upper limit amount for that progressive jackpot award, and has created and was maintaining a third progressive jackpot award that was at $325, 100 at the time of purchase of the third draw lottery ticket 310C. The third draw lottery ticket 310C also indicates that the third progressive jackpot award has an upper limit amount of $400,000, and when the draw lottery ticket system determines that the third progressive jackpot award reaches that upper limit amount, the draw lottery ticket system will set the third progressive jackpot award at that upper limit amount, create a fourth progressive jackpot award, and provide an additional drawing for the single play of the draw lottery game for that fourth progressive jackpot award.

In this example single play of the draw lottery game, at the draw time, the draw lottery ticket system causes three separate draws to occur respectively corresponding to the first, second, and third progressive jackpot awards.

In this example, for the first drawing associated with the first progressive jackpot award of $500,000 the drawn numbers are: 17, 22, 30, 34 44, and 45.

In this example, for the second drawing associated with the second progressive jackpot award of $400,000, the drawn numbers are: 02, 03, 04, 11, 25, and 30.

In this example, for the third drawing associated with the third progressive jackpot of $370,000 (which increased after the purchase of the third lottery ticket 310C) in this example, the drawn numbers are: 14, 25, 47, 54, 55, and 68.

In this example, the first lottery ticket 310A has six numbers that match the six numbers of the third drawing, so the draw lottery ticket system determines that the holder of the first lottery ticket 310A can redeem that ticket for the third progressive jackpot award of $370,000.

In the example, the second lottery ticket 310B has four numbers that match the six numbers of the first drawing so the draw lottery ticket system determines that the holder of the second lottery ticket 310B can redeem one of the secondary awards associated with the first progressive jackpot award (for the four number match). Additionally, since no draw lottery ticket for this single play of the draw lottery game has six numbers that match the drawn numbers for the first drawing for this play of the draw lottery game, the draw lottery ticket system rolls over the first progressive jackpot award of $500,000 to the next single play of the draw lottery game.

In this example, the third lottery ticket 310C has six numbers that match the six numbers of the second drawing, so the draw lottery ticket system determines that the holder of the third lottery ticket 310C can redeem the third lottery ticket 310C for the second progressive jackpot award of $400,000.

This example shows that: (1) multiple separate progressive jackpot awards can be created and won for the same single play of the draw lottery game based on multiple drawings for that single play of the draw lottery game; and (2) that each draw lottery ticket (whether or not purchased before an extra progressive jackpot award is created still qualifies for the extra drawings for that single play of the draw lottery game.

In alternative embodiments, one or more secondary awards can be associated with one or more of the multiple separate progressive jackpot awards.

It should be appreciated from that above that various embodiments of the present disclosure provide a draw lottery ticket system configured to: (1) grow a first progressive jackpot award for a draw lottery game based on purchases of draw lottery tickets for the draw lottery game; (2) responsive to determining that the first progressive jackpot award is not won and reaches a first upper limit amount: (a) set that first progressive jackpot award at that first upper limit amount, (b) create a second progressive jackpot award for the draw lottery game, and (c) grow the second progressive jackpot award based on subsequent purchases of the draw lottery tickets for that draw lottery game; and (3) responsive to determining that the second progressive jackpot award is not won and reaches a second upper limit amount: (a) set that second progressive jackpot award at that second upper limit amount, (b) create a third progressive jackpot award for the draw lottery game, and (c) grow the third progressive jackpot award based on subsequent purchases of the draw lottery tickets for that draw lottery game. In various such embodiments, the first upper limit is the same as the second upper limit. In various such embodiments, the first upper limit is different than second upper limit. In various such embodiments, draw lottery ticket system is further configured to, when only the first progressive jackpot award exists for a single play of the draw lottery game: (i) provide a first drawing for the single play of the draw lottery game, (ii) based on the first drawing, determine if any of the draw lottery tickets for that single play of the draw lottery game wins the first progressive jackpot award or any secondary awards associated with the first progressive jackpot award, (iii) based on the first drawing, determine if any of the draw lottery tickets for that single play of the draw lottery game win any secondary awards associated with the first progressive jackpot award, (iv) if one of the draw lottery tickets wins the first progressive jackpot award, cause that first progressive jackpot award to be available to be provided to a holder of that winning draw lottery ticket upon redemption of that winning draw lottery ticket, (v) if none of the draw lottery tickets win the first progressive jackpot award, roll over that first progressive jackpot award for a next play of the draw lottery game, and (vi) if one of the draw lottery tickets win any of the secondary awards, cause that secondary award to be available to be provided to a holder of that winning draw lottery ticket upon redemption of that winning draw lottery ticket. In various such embodiments, draw lottery ticket system is further configured to, when the first progressive jackpot award exists and the second progressive jackpot award exists: (i) provide a first drawing for the single play of the draw lottery game, (ii) based on the first drawing, determine if any of the draw lottery tickets win the first progressive jackpot award, (iii) provide a second drawing for that same single play of the draw lottery game, and (iv) based on the second drawing, determine if any of the draw lottery tickets win the second progressive jackpot award. In various such embodiments, draw lottery ticket system is further configured to, (i) if one of the draw lottery tickets wins the first progressive jackpot award based on the first drawing, cause that first progressive jackpot award to be available provided to a holder of that draw lottery ticket upon redemption of that winning draw lottery ticket, (ii) if none of the draw lottery tickets win the first progressive jackpot award, roll over that first progressive jackpot award for a next play of the draw lottery game, (iii) if one of the draw lottery tickets wins the second progressive jackpot award based on the second drawing, cause that second progressive jackpot award to be available to be provided to a holder of that draw lottery ticket upon redemption of that winning draw lottery ticket, and (iv) if none of the draw lottery tickets win the second progressive jackpot award, roll over that second progressive jackpot award for the next play of the draw lottery game. In various such embodiments, draw lottery ticket system is further configured to, when the first progressive jackpot award exists and the second progressive jackpot award exists: (i) provide a first drawing for the single play of the draw lottery game, (ii) based on the first drawing, determine if any of the draw lottery tickets win the first progressive jackpot award, (iii) based on the first drawing, determine if any of the draw lottery tickets win any secondary award, (iv) provide a second drawing for that same single play of the draw lottery game, and (v) based on the second drawing, determine if any of the draw lottery tickets win the second progressive jackpot award, wherein no secondary awards are associated with the second progressive jackpot award. In various such embodiments, draw lottery ticket system is further configured to, (i) if one of the draw lottery tickets wins the first progressive jackpot award based on the first drawing, cause that first progressive jackpot award to be available provided to a holder of that draw lottery ticket upon redemption of that winning draw lottery ticket, (ii) if none of the draw lottery tickets win the first progressive jackpot award, roll over that first progressive jackpot award for a next play of the draw lottery game, (iii) if one of the draw lottery tickets wins the second progressive jackpot award based on the second drawing, cause that second progressive jackpot award to be available to be provided to a holder of that draw lottery ticket upon redemption of that winning draw lottery ticket, and (iv) if none of the draw lottery tickets win the second progressive jackpot award, roll over that second progressive jackpot award for the next play of the draw lottery game. In various such embodiments, draw lottery ticket system is further configured to, when the first progressive jackpot award exists, the second progressive jackpot award exists, and the third progressive jackpot award exists: (i) provide a first drawing for the single play of the draw lottery game, (ii) based on the first drawing, determine if any of the draw lottery tickets win the first progressive jackpot award, (iii) based on the first drawing, determine if any of the draw lottery tickets win any secondary award, (iv) provide a second drawing for that same single play of the draw lottery game, (v) based on the second drawing, determine if any of the draw lottery tickets win the second progressive jackpot award, wherein the second progressive jackpot award is not associated with any secondary awards, (vi) provide a third drawing for that same single play of the draw lottery game, and (vii) based on the third drawing, determine if any of the draw lottery tickets win the third progressive jackpot award, wherein the third progressive jackpot award is not associated with any secondary awards. In various such embodiments, draw lottery ticket system is further configured to, (i) if one of the draw lottery tickets wins the first progressive jackpot award based on the first drawing, cause that first progressive jackpot award to be available to be provided to a holder of that draw lottery ticket upon redemption of that winning draw lottery ticket, (ii) if none of the draw lottery tickets win the first progressive jackpot award, roll over that first progressive jackpot award for a next play of the draw lottery game, (iii) if one of the draw lottery tickets wins the second progressive jackpot award based on the second drawing, cause that second progressive jackpot award to be available to be provided to a holder of that draw lottery ticket upon redemption of that winning draw lottery ticket, (iv) if none of the draw lottery tickets win the second progressive jackpot award, roll over that second progressive jackpot award for the next play of the draw lottery game, (v) if one of the draw lottery tickets wins the third progressive jackpot award based on the third drawing, cause that third progressive jackpot award to be available to be provided to a holder of that draw lottery ticket upon redemption of that winning draw lottery ticket, and (vi) if none of the draw lottery tickets win the third progressive jackpot award, then the draw lottery ticket system rolls over that third progressive jackpot award for the next play of the draw lottery game.

It should further be appreciated from that above that various embodiments of the present disclosure provide a draw lottery ticket system configured to: (1) grow a first progressive jackpot award for a draw lottery game based on purchases of draw lottery tickets for the draw lottery game; (2) responsive to determining that the first progressive jackpot award is not won and reaches a first upper limit amount: (a) set that first progressive jackpot award at that first upper limit amount, (b) create a second progressive jackpot award for the draw lottery game, and (c) grow the second progressive jackpot award based on subsequent purchases of the draw lottery tickets for that draw lottery game; and (3) for the first progressive jackpot award for a single play of the draw lottery game: (a) provide one drawing for the single play of the draw lottery game, (b) based on that first drawing, determine if any of the draw lottery tickets for that single play of the draw lottery game wins the first progressive jackpot award, (c) based on that first drawing, determine if any of the draw lottery tickets for that single play of the draw lottery game wins any secondary awards associated with the first progressive jackpot award, (d) if one of the draw lottery tickets wins the first progressive jackpot award, cause that first progressive jackpot award to be available to be provided to a holder of that winning draw lottery ticket upon redemption of that winning draw lottery ticket, (e) if none of the draw lottery tickets wins the first progressive jackpot award, roll over that first progressive jackpot award for a next play of the draw lottery game, and (f) if one of the draw lottery tickets wins any of secondary awards, cause that secondary award to be available to be provided to a holder of that winning draw lottery ticket upon redemption of that winning draw lottery ticket. In various such embodiments, draw lottery ticket system is further configured to, when the second progressive jackpot award also exists: (i) provide a second drawing for the single play of the draw lottery game, (ii) based on that second drawing, determine if any of the draw lottery tickets for that single play of the draw lottery game wins the second progressive jackpot award, (iii) if one of the draw lottery tickets wins the second progressive jackpot award, cause that second progressive jackpot award to be available to be provided to a holder of that winning draw lottery ticket upon redemption of that winning draw lottery ticket, and (iv) if none of the draw lottery tickets wins the second progressive jackpot award, roll over that second progressive jackpot award for the next play of the draw lottery game. In various such embodiments, no secondary awards are associate with the second progressive jackpot award.

It should further be appreciated from that above that various embodiments of the present disclosure provide a draw lottery ticket system configured to: (1) grow a first progressive jackpot award for a draw lottery game based on purchases of draw lottery tickets for the draw lottery game; (2) after determining that the first progressive jackpot award has not been won and has reached a first upper limit amount: (a) set that first progressive jackpot award at that first upper limit amount, (b) create a second progressive jackpot award for the draw lottery game, and (c) grow the second progressive jackpot award based on subsequent purchases of the draw lottery tickets for that draw lottery game; (3) after determining that the second progressive jackpot award has not been won and has reached a second upper limit amount: (a) set that second progressive jackpot award at that second upper limit amount, (b) create a third progressive jackpot award for the draw lottery game, and (c) grow the third progressive jackpot award based on subsequent purchases of the draw lottery tickets for that draw lottery game; (4) for the first progressive jackpot award for a single play of the draw lottery game: (a) provide a first drawing for the single play of the draw lottery game, (b) based on that first drawing, determine if any of the draw lottery tickets for that single play of the draw lottery game wins the first progressive jackpot award, and (c) if one of the draw lottery tickets wins the first progressive jackpot award, cause that first progressive jackpot award to be available to be provided to a holder of that winning draw lottery ticket upon redemption of that winning draw lottery ticket; (5) for the second progressive jackpot award for the single play of the draw lottery game: (a) provide a second drawing for the single play of the draw lottery game, (b) based on that second drawing, determine if any of the draw lottery tickets for that single play of the draw lottery game wins the second progressive jackpot award, and (c) if one of the draw lottery tickets wins the second progressive jackpot award, cause that second progressive jackpot award to be available to be provided to a holder of that winning draw lottery ticket upon redemption of that winning draw lottery ticket; and (6) for the third progressive jackpot award for the single play of the draw lottery game: (a) provide a third drawing for the single play of the draw lottery game, (b) based on that third drawing, determine if any of the draw lottery tickets for that single play of the draw lottery game wins the third progressive jackpot award, and (c) if one of the draw lottery tickets wins the third progressive jackpot award, cause that third progressive jackpot award to be available to be provided to a holder of that winning draw lottery ticket upon redemption of that winning draw lottery ticket. In various such embodiments, the first upper limit is the same as the second upper limit. In various such embodiments, the first upper limit is different than second upper limit. In various such embodiments, draw lottery ticket system is further configured to (i) if none of the draw lottery tickets wins the first progressive jackpot award for the single play of the draw lottery game, roll over that first progressive jackpot award for a next play of the draw lottery game, (ii) if none of the draw lottery tickets wins the second progressive jackpot award for the single play of the draw lottery game, roll over that second progressive jackpot award for the next play of the draw lottery game, and (iii) if none of the draw lottery tickets wins the third progressive jackpot award for the single play of the draw lottery game, roll over that third progressive jackpot award for the next play of the draw lottery game. In various such embodiments, a secondary award is associated with the first progressive jackpot award, but not the second or third progressive jackpot awards, and the draw lottery ticket system is further configured to: (i) based on the first drawing, determine if any of the draw lottery tickets for that single play of the draw lottery game wins the secondary award associated with the first progressive jackpot award, and (ii) if one of the draw lottery tickets wins the secondary award, cause that secondary award to be available to be provided to a holder of that winning draw lottery ticket upon redemption of that winning draw lottery ticket. In various such embodiments, a secondary award is associated with the second progressive jackpot award, but not the first or third progressive jackpot awards, and the draw lottery ticket system is further configured to: (i) based on the second drawing, determine if any of the draw lottery tickets for that single play of the draw lottery game wins the secondary award associated with the second progressive jackpot award, and (ii) if one of the draw lottery tickets wins the secondary award, cause that secondary award to be available to be provided to a holder of that winning draw lottery ticket upon redemption of that winning draw lottery ticket. In various such embodiments, a secondary award is associated with the third progressive jackpot award, but not the first or second progressive jackpot awards, and the draw lottery ticket system is further configured to: (i) based on the third drawing, determine if any of the draw lottery tickets for that single play of the draw lottery game wins the secondary award associated with the third progressive jackpot award, and (ii) if one of the draw lottery tickets wins the secondary award, cause that secondary award to be available to be provided to a holder of that winning draw lottery ticket upon redemption of that winning draw lottery ticket.

### Example Draw Lottery Ticket Systems—General

In various embodiments, the draw lottery ticket system and method are configured to be provided by a lottery agency (such as a state lottery agency).

In various embodiments, the draw lottery ticket system and method are configured to be provided by a third party that runs the lottery for a lottery agency (such as a state lottery agency).

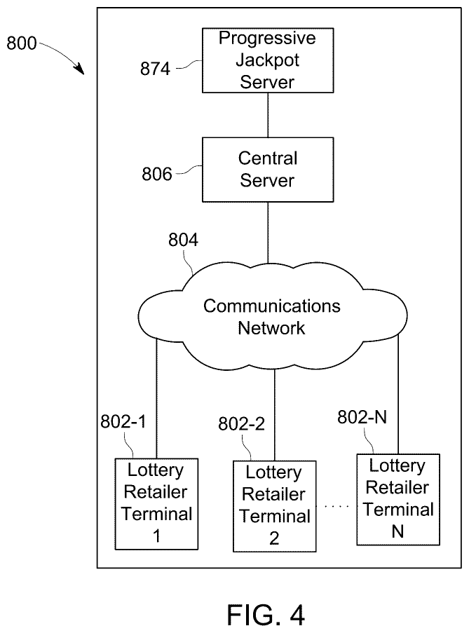

In various embodiments of the draw lottery ticket system, the player can purchase the lottery ticket via any suitable manner such as, but not limited to, one of the following: (1) a dedicated lottery kiosk (e.g., a lottery kiosk) configured to communicate over a data network (such as the Internet) to a lottery server (such as a central server 806 described below in connection with FIG. 4); (2) a retailer-operated lottery terminal configured to communicate over a data network (such as the Internet) to a lottery server (such as a central server 806 described below in connection with FIG. 4); (3) a personal computer configured to communicate over a data network (such as the Internet) to a lottery server (such as a central server 806 described below in connection with FIG. 4); and/or (4) a personal mobile device (such as a cellular telephone, tablet, or PDA) configured to communicate over a data network (such as a wireless or cellular data network) to a lottery server (such as a central server 806 described below in connection with FIG. 4).

In various embodiments, the draw lottery ticket system enables a player to use a paper playslip to purchase a lottery ticket at a retail location having a lottery terminal configured to receive the playslip and print the lottery ticket at the time of purchase in a conventional manner. The retail operator can receive the purchase price for the lottery ticket from the player in any suitable manner.

In various embodiments, the draw lottery ticket system enables a player to use a virtual playslip to purchase a lottery ticket through a retail lottery kiosk configured to display the playslip (as further described below), receive the player selections using the displayed playslip (as further described below), receive the wager from the player, and print the lottery ticket at the time of purchase. This example lottery kiosk can include an integral printer device and/or be in communication with a printer device for providing a printed lottery ticket to the player.

In various embodiments, the draw lottery ticket system enables a player to use a virtual playslip to purchase a lottery ticket electronically using a personal mobile device such as the player's mobile telephone. In one such embodiment, the draw lottery ticket system receives from this device the player selections and the wager from the player, and sends the player a virtual lottery ticket (which in certain instances can be printed by the player using a suitable personal printing device). Thus, it should be appreciated that in various example embodiments, the player can purchase a lottery ticket with a personal mobile device and, thus, may not be provided with a physical (i.e., paper) lottery ticket. Instead, an electronic (or virtual) version of the lottery ticket is provided to the player via, for example, an electronic mail to an email account associated with the player.

FIG. 4 illustrates an example networked draw lottery ticket system 800 for either implementation. This example network draw lottery ticket system 800 generally includes: (1) a plurality of lottery retailer terminals 802-1 to 802-N; (2) a communications network 804; (3) one or more central servers such as central server 806; and (4) the progressive jackpot server 874. Generally, the retailer terminals 802-1 to 802-N and the central server 806 are configured to perform the functions described above and further described below.

In this example embodiment, each retailer terminal 802 corresponds to (or is associated with) a particular lottery retailer. For example, the first retailer terminal 802-1 of FIG. 4 can be associated with a first lottery retailer, such as a convenience store, and the second retailer terminal 802-2 of FIG. 4 can be associated with a second lottery retailer, such as a supermarket. Any suitable quantity of lottery retailer terminals can be employed in the draw lottery ticket system 800, along with any suitable quantity of corresponding central servers 806.

In various embodiments, the lottery retailer terminal 802 includes one or more processor(s). Generally, the processor is operative to perform or process instructions, and in particular, to operate in accordance with the various methods described herein. For example, the processor of the lottery retailer terminal 802 can be operable to enable the lottery retailer terminal 802 to transmit data to (and receive data from) the central server 806. More specifically, the processor can enable the transmission of data representing each lottery ticket.

In various example embodiments, the lottery retailer terminal 802 includes one or more input device(s). The input devices of the lottery retailer terminal 802 can include components such as an optical scanner and/or a barcode scanner, for reading and/or for deriving information associated with a playslip and/or a lottery ticket. For example, a lottery ticket can include registration marks, authenticity data, various codes, micro-printed indicia, one or more sense marks, and/or other lottery indicia that must be read. Examples of additional input devices include, but are not limited to, a keypad, a mouse, an image capturing device (e.g., an optical character recognition (OCR) device), a biometric reader, a portable storage device (e.g., a memory stick), and the like.

In various embodiments, the input device(s) of the lottery retailer terminal 802 can include a clock. The clock can be employed to detect, derive and/or append time and/or date information for use by the central server 806 to: (i) create a data record corresponding to lottery tickets purchased at the lottery retailer terminal 802, (ii) to determine redemption time, round and/or date information associated with lottery tickets, and/or (iii) determine whether a lottery player has redeemed their lottery ticket in a manner that qualifies the player to receive a particular redemption amount (for example, if the player makes a lottery ticket redemption request prior to the revealing of a full lottery outcome).

In various embodiments, the lottery retailer terminal 802 includes one or more output device(s). Such output device(s) can include such components as a display for outputting information to a lottery player or to a terminal operator (e.g., win/loss information and/or payout amounts), one or more benefit output devices (e.g., a cash drawer, a currency dispenser), a printer for producing a physical record (e.g., paper slip, receipt, ticket, voucher, coupon, etc.) that defines a lottery ticket, audio/video output device(s), and the like.

In various embodiments, the lottery retailer terminal 802 also includes one or more communications port(s), such as a serial port, a modem or the like. Generally, the communications port of the lottery retailer terminal 802 can be operable to facilitate two-way data communications between (i) the lottery retailer terminal 802, and (ii) the central server 806. In accordance with some embodiments, the communications port of the lottery retailer terminal 802 can operate to facilitate the transmission of information between the lottery retailer terminal and a player device such as a personal digital assistant (PDA), cell phone and/or a dedicated (e.g., a proprietary) device.

In various embodiments, the lottery retailer terminal 802 includes a data storage device such as a hard disk, optical or magnetic media, random access memory (RAM) and/or read-only memory (ROM), or the like memory device. Generally, the data storage device of the lottery retailer terminal 802 stores a software program, the software program enabling a processor of the retailer terminal 802 to perform various functions including some or all of the various steps described herein. For example, as noted above with respect to FIGS. 1 to 3C, in accordance with certain embodiments, the lottery retailer terminal 802 can be configured to perform some or all of the functions of the central server 806 (and vice versa) such that the central server 806 and the lottery retailer terminal 802 can be considered as the same “device.”

In various embodiments, a lottery sales device can be utilized in place of a lottery retailer terminal 802. Such a lottery sales device can be implemented as a lottery server, a controller, a dedicated hardware circuit, an appropriately programmed general-purpose computer, or any other equivalent electronic, mechanical or electro-mechanical device. Thus, in various embodiments, a lottery sales device can include, for example, but is not limited to: (1) a video lottery terminal that can include a touch sensitive screen for use by a player; (2) a personal computer (e.g., which communicates with a remote lottery server); or (3) a personal mobile device such as a mobile telephone, a tablet, or a personal digital assistant. The lottery sales device can include any or all of the devices of the aforementioned systems.

In this example embodiment, the central server 806 operates to: (1) receive and/or store data associated with one or more draw lottery tickets including such data as: (a) ticket identifier(s), and (b) ticket indicia; (2) determine at least a first redemption amount associated with a draw lottery ticket; (3) receive a redemption request associated with the draw lottery ticket; (4) determine a time of play associated with the redemption request; and (5) transmit an indication of the appropriate redemption amount to a lottery retailer terminal (e.g., for output or display to a lottery player and/or lottery terminal operator).

In various embodiments, the central server 806 includes one or more processor(s). Such a processor functions to process instructions, and in particular, to operate in accordance with various methods described herein. For example, the processor can operate to enable the central server 806 to transmit data to (and receive data from) the lottery retailer terminal 802. More specifically, the processor of the central server 806 can enable the transmission of data representing a lottery ticket, as well as information defining one or more payout(s) associated with that lottery ticket to or by a specific one of the lottery retailer terminals 802 shown in the lottery network 800 of FIG. 4. Thus, the central server 806 can be implemented as a system controller, a dedicated hardware circuit, an appropriately and particularly programmed general-purpose computer, or any other equivalent electronic, mechanical or electro-mechanical device capable of providing for one or more of the embodiments described herein.

In various embodiments, the central server 806 includes one or more input device(s). Examples of such input devices include a keypad, a mouse, a touch-screen, a random number generator, a microphone, and other digital or analog input devices.

In various embodiments, the central server 806 also includes one or more output device(s). Example of output device(s) of the central server 806 include a monitor or other display for outputting information to an operator of the central server 806 (e.g., for displaying information such as statistical or sales data, win and loss information and/or payout amounts), a printer for producing a physical record (e.g., a report) of such data, and the like. In addition, the central server 806 can include one or more communications ports, such as a serial port, modem or the like, operable to facilitate two-way data communications between (i) the central server 806 and (ii) one or more lottery retailer terminals 802.

In various embodiments, the central server 806 includes a data storage device (e.g., a hard disk or hard drive, a media-based (removable) memory, or the like). In certain embodiments, the data storage device of the central server 806 stores at least one software program, which includes a program to enable the processor of the central server 806 to perform some or all of the various steps and functions of at least one implementation of the methods described in detail herein. In addition, the data storage device of the central server 806 can operate to store one or more databases including a lottery ticket database and a lottery ticket redemption status database.

In various embodiments, the central server 806 includes a lottery ticket server device that is located at a lottery ticket printing facility, and can also function to manage the ticket printing process. The central server 806 can also function to develop a lottery game matrix (e.g., determining base payouts, win frequencies, and the like) and to match static lottery content with secure paytable (or payout distribution) data. In certain embodiments, a lottery ticket printer device for use in such draw lottery ticket systems can utilize the game matrix information from the central server and can apply it to the secure paytable data.

In various embodiments, a retailer terminal (such as the first retailer terminal 802-1) of FIG. 4 is configured to perform some or all of the functions of the central server 806. Thus, in certain embodiments, the central server 806 and the retailer terminal (such as the first retailer terminal 802-1) (or another given retailer terminal and server pairing) can be considered as the same “device.”

Generally, the communications network 804 of FIG. 4 includes one or more local and/or wide-area network(s) proprietary and/or public network(s) (e.g., the Internet) for facilitating two-way data communications between the retailer terminals 802 and the central server 806. The central server 806 can communicate with lottery retailer terminals 802 directly or indirectly, via a wired or wireless medium, such as via the Internet, via a local area network (LAN), via a wide area network (WAN), via an Ethernet, via a Token Ring, via a telephone line, via a cable line, via a radio channel, via an optical communications line, via a satellite communications link, or via any other appropriate communications system or combinations thereof. Any quantities and types of devices can be in communication with the central server 806, and communication between the lottery retailer terminals 802 and the central server 806 can be direct or indirect. A variety of communications protocols can be part of any such communications system, including, but not limited to: Ethernet (or IEEE 802.3), SAP, ATP, Bluetooth™, and TCP/IP.

It should be understood that devices in communication with each other need not be continually transmitting to each other. On the contrary, such devices need only transmit to each other as necessary, and may actually refrain from exchanging data most of the time. For example, a device in communication with another device via the Internet may not transmit data to the other device for days or weeks at a time. In some embodiments, a server may not be necessary and/or preferred.

As used herein, a lottery retailer can include a merchant who sells draw lottery tickets at a particular location, authenticates winning draw lottery tickets, redeems authenticated winning draw lottery tickets, and/or provides awards to players for winning draw lottery tickets. Examples of various lottery retailers include, but are not limited to, convenience stores, gas stations, supermarkets, and other retail establishments.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A draw lottery ticket system comprising:
a processor; and
a memory device that stores a plurality of instructions, which when executed by the processor, cause the processor to:
grow a first progressive jackpot award for a draw lottery game based on purchases of draw lottery tickets for the draw lottery game;
responsive to determining that the first progressive jackpot award is not won and reaches a first upper limit amount:
set that first progressive jackpot award at that first upper limit amount,
create a second progressive jackpot award for the draw lottery game, and
grow the second progressive jackpot award based on subsequent purchases of the draw lottery tickets for that draw lottery game; and
responsive to determining that the second progressive jackpot award is not won and reaches a second upper limit amount:
set that second progressive jackpot award at that second upper limit amount,
create a third progressive jackpot award for the draw lottery game, and
grow the third progressive jackpot award based on subsequent purchases of the draw lottery tickets for that draw lottery game.

2. The draw lottery ticket system of claim 1, wherein the first upper limit is the same as the second upper limit.

3. The draw lottery ticket system of claim 1, wherein the first upper limit is different than second upper limit.

4. The draw lottery ticket system of claim 1, wherein the plurality of instructions, when executed by the processor, cause the processor to, when only the first progressive jackpot award exists for a single play of the draw lottery game:
provide a first drawing for the single play of the draw lottery game,
based on the first drawing, determine if any of the draw lottery tickets for that single play of the draw lottery game wins the first progressive jackpot award or any secondary awards associated with the first progressive jackpot award,
based on the first drawing, determine if any of the draw lottery tickets for that single play of the draw lottery game win any secondary awards associated with the first progressive jackpot award,
if one of the draw lottery tickets wins the first progressive jackpot award, cause that first progressive jackpot award to be available to be provided to a holder of that winning draw lottery ticket upon redemption of that winning draw lottery ticket,
if none of the draw lottery tickets win the first progressive jackpot award, roll over that first progressive jackpot award for a next play of the draw lottery game, and
if one of the draw lottery tickets win any of the secondary awards, cause that secondary award to be available to be provided to a holder of that winning draw lottery ticket upon redemption of that winning draw lottery ticket.

5. The draw lottery ticket system of claim 1, wherein the plurality of instructions, when executed by the processor, cause the processor to, when the first progressive jackpot award exists and the second progressive jackpot award exists:
provide a first drawing for the single play of the draw lottery game,
based on the first drawing, determine if any of the draw lottery tickets win the first progressive jackpot award,
provide a second drawing for that same single play of the draw lottery game, and
based on the second drawing, determine if any of the draw lottery tickets win the second progressive jackpot award.

6. The draw lottery ticket system of claim 5, wherein the plurality of instructions, when executed by the processor, cause the processor to:
if one of the draw lottery tickets wins the first progressive jackpot award based on the first drawing, cause that first progressive jackpot award to be available provided to a holder of that draw lottery ticket upon redemption of that winning draw lottery ticket,
if none of the draw lottery tickets win the first progressive jackpot award, roll over that first progressive jackpot award for a next play of the draw lottery game,
if one of the draw lottery tickets wins the second progressive jackpot award based on the second drawing, cause that second progressive jackpot award to be available to be provided to a holder of that draw lottery ticket upon redemption of that winning draw lottery ticket, and
if none of the draw lottery tickets win the second progressive jackpot award, roll over that second progressive jackpot award for the next play of the draw lottery game.

7. The draw lottery ticket system of claim 1, wherein the plurality of instructions, when executed by the processor, cause the processor to, when the first progressive jackpot award exists and the second progressive jackpot award exists:
provide a first drawing for the single play of the draw lottery game,
based on the first drawing, determine if any of the draw lottery tickets win the first progressive jackpot award,
based on the first drawing, determine if any of the draw lottery tickets win any secondary award,
provide a second drawing for that same single play of the draw lottery game, and
based on the second drawing, determine if any of the draw lottery tickets win the second progressive jackpot award, wherein no secondary awards are associated with the second progressive jackpot award.

8. The draw lottery ticket system of claim 7, wherein the plurality of instructions, when executed by the processor, cause the processor to:
if one of the draw lottery tickets wins the first progressive jackpot award based on the first drawing, cause that first progressive jackpot award to be available provided to a holder of that draw lottery ticket upon redemption of that winning draw lottery ticket,
if none of the draw lottery tickets win the first progressive jackpot award, roll over that first progressive jackpot award for a next play of the draw lottery game, if one of the draw lottery tickets wins the second progressive jackpot award based on the second drawing, cause that second progressive jackpot award to be available to be provided to a holder of that draw lottery ticket upon redemption of that winning draw lottery ticket, and
if none of the draw lottery tickets win the second progressive jackpot award, roll over that second progressive jackpot award for the next play of the draw lottery game.

9. The draw lottery ticket system of claim 1, wherein the plurality of instructions, when executed by the processor, cause the processor to, when the first progressive jackpot award exists, the second progressive jackpot award exists, and the third progressive jackpot award exists:
provide a first drawing for the single play of the draw lottery game,
based on the first drawing, determine if any of the draw lottery tickets win the first progressive jackpot award,
based on the first drawing, determine if any of the draw lottery tickets win any secondary award,
provide a second drawing for that same single play of the draw lottery game,
based on the second drawing, determine if any of the draw lottery tickets win the second progressive jackpot award, wherein the second progressive jackpot award is not associated with any secondary awards,
provide a third drawing for that same single play of the draw lottery game, and
based on the third drawing, determine if any of the draw lottery tickets win the third progressive jackpot award, wherein the third progressive jackpot award is not associated with any secondary awards.

10. The draw lottery ticket system of claim 9, wherein the plurality of instructions, when executed by the processor, cause the processor to:
if one of the draw lottery tickets wins the first progressive jackpot award based on the first drawing, cause that first progressive jackpot award to be available to be provided to a holder of that draw lottery ticket upon redemption of that winning draw lottery ticket,
if none of the draw lottery tickets win the first progressive jackpot award, roll over that first progressive jackpot award for a next play of the draw lottery game,
if one of the draw lottery tickets wins the second progressive jackpot award based on the second drawing, cause that second progressive jackpot award to be available to be provided to a holder of that draw lottery ticket upon redemption of that winning draw lottery ticket,
if none of the draw lottery tickets win the second progressive jackpot award, roll over that second progressive jackpot award for the next play of the draw lottery game,
if one of the draw lottery tickets wins the third progressive jackpot award based on the third drawing, cause that third progressive jackpot award to be available to be provided to a holder of that draw lottery ticket upon redemption of that winning draw lottery ticket, and
if none of the draw lottery tickets win the third progressive jackpot award, then the draw lottery ticket system rolls over that third progressive jackpot award for the next play of the draw lottery game.

11. A draw lottery ticket system comprising:
a processor; and
a memory device that stores a plurality of instructions, which when executed by the processor, cause the processor to:
grow a first progressive jackpot award for a draw lottery game based on purchases of draw lottery tickets for the draw lottery game;
responsive to determining that the first progressive jackpot award is not won and reaches a first upper limit amount:
set that first progressive jackpot award at that first upper limit amount,
create a second progressive jackpot award for the draw lottery game, and
grow the second progressive jackpot award based on subsequent purchases of the draw lottery tickets for that draw lottery game; and
for the first progressive jackpot award for a single play of the draw lottery game:
provide one drawing for the single play of the draw lottery game,
based on that first drawing, determine if any of the draw lottery tickets for that single play of the draw lottery game wins the first progressive jackpot award,
based on that first drawing, determine if any of the draw lottery tickets for that single play of the draw lottery game wins any secondary awards associated with the first progressive jackpot award,
if one of the draw lottery tickets wins the first progressive jackpot award, cause that first progressive jackpot award to be available to be provided to a holder of that winning draw lottery ticket upon redemption of that winning draw lottery ticket,
if none of the draw lottery tickets wins the first progressive jackpot award, roll over that first progressive jackpot award for a next play of the draw lottery game, and
if one of the draw lottery tickets wins any of secondary awards, cause that secondary award to be available to be provided to a holder of that winning draw lottery ticket upon redemption of that winning draw lottery ticket.

12. The draw lottery ticket system of claim 11, wherein the plurality of instructions, when executed by the processor, cause the processor to:
when the second progressive jackpot award also exists:
provide a second drawing for the single play of the draw lottery game, based on that second drawing, determine if any of the draw lottery tickets for that single play of the draw lottery game wins the second progressive jackpot award,
if one of the draw lottery tickets wins the second progressive jackpot award, cause that second progressive jackpot award to be available to be provided to a holder of that winning draw lottery ticket upon redemption of that winning draw lottery ticket, and
if none of the draw lottery tickets wins the second progressive jackpot award, roll over that second progressive jackpot award for the next play of the draw lottery game.

13. The draw lottery ticket system of claim 12, wherein no secondary awards are associate with the second progressive jackpot award.

14. A draw lottery ticket system comprising:
a processor; and
a memory device that stores a plurality of instructions, which when executed by the processor, cause the processor to:
grow a first progressive jackpot award for a draw lottery game based on purchases of draw lottery tickets for the draw lottery game;
after determining that the first progressive jackpot award has not been won and has reached a first upper limit amount:
set that first progressive jackpot award at that first upper limit amount,
create a second progressive jackpot award for the draw lottery game, and
grow the second progressive jackpot award based on subsequent purchases of the draw lottery tickets for that draw lottery game;
after determining that the second progressive jackpot award has not been won and has reached a second upper limit amount:
set that second progressive jackpot award at that second upper limit amount,
create a third progressive jackpot award for the draw lottery game, and
grow the third progressive jackpot award based on subsequent purchases of the draw lottery tickets for that draw lottery game;
for the first progressive jackpot award for a single play of the draw lottery game:
provide a first drawing for the single play of the draw lottery game,
based on that first drawing, determine if any of the draw lottery tickets for that single play of the draw lottery game wins the first progressive jackpot award, and
if one of the draw lottery tickets wins the first progressive jackpot award, cause that first progressive jackpot award to be available to be provided to a holder of that winning draw lottery ticket upon redemption of that winning draw lottery ticket;
for the second progressive jackpot award for the single play of the draw lottery game:
provide a second drawing for the single play of the draw lottery game,
based on that second drawing, determine if any of the draw lottery tickets for that single play of the draw lottery game wins the second progressive jackpot award, and
if one of the draw lottery tickets wins the second progressive jackpot award, cause that second progressive jackpot award to be available to be provided to a holder of that winning draw lottery ticket upon redemption of that winning draw lottery ticket; and
for the third progressive jackpot award for the single play of the draw lottery game:
provide a third drawing for the single play of the draw lottery game,
based on that third drawing, determine if any of the draw lottery tickets for that single play of the draw lottery game wins the third progressive jackpot award, and
if one of the draw lottery tickets wins the third progressive jackpot award, cause that third progressive jackpot award to be available to be provided to a holder of that winning draw lottery ticket upon redemption of that winning draw lottery ticket.

15. The draw lottery ticket system of claim 14, wherein the first upper limit is the same as the second upper limit.

16. The draw lottery ticket system of claim 14, wherein the first upper limit is different than second upper limit.

17. The draw lottery ticket system of claim 14, wherein the plurality of instructions, when executed by the processor, cause the processor to:
if none of the draw lottery tickets wins the first progressive jackpot award for the single play of the draw lottery game, roll over that first progressive jackpot award for a next play of the draw lottery game,
if none of the draw lottery tickets wins the second progressive jackpot award for the single play of the draw lottery game, roll over that second progressive jackpot award for the next play of the draw lottery game, and
if none of the draw lottery tickets wins the third progressive jackpot award for the single play of the draw lottery game, roll over that third progressive jackpot award for the next play of the draw lottery game.

18. The draw lottery ticket system of claim 14, wherein a secondary award is associated with the first progressive jackpot award, but not the second or third progressive jackpot awards, and wherein the plurality of instructions, when executed by the processor, cause the processor to:
based on the first drawing, determine if any of the draw lottery tickets for that single play of the draw lottery game wins the secondary award associated with the first progressive jackpot award, and
if one of the draw lottery tickets wins the secondary award, cause that secondary award to be available to be provided to a holder of that winning draw lottery ticket upon redemption of that winning draw lottery ticket.

19. The draw lottery ticket system of claim 14, wherein a secondary award is associated with the second progressive jackpot award, but not the first or third progressive jackpot awards, and wherein the plurality of instructions, when executed by the processor, cause the processor to:
based on the second drawing, determine if any of the draw lottery tickets for that single play of the draw lottery game wins the secondary award associated with the second progressive jackpot award, and
if one of the draw lottery tickets wins the secondary award, cause that secondary award to be available to be provided to a holder of that winning draw lottery ticket upon redemption of that winning draw lottery ticket.

20. The draw lottery ticket system of claim 13, wherein a secondary award is associated with the third progressive jackpot award, but not the first or second progressive jackpot awards, and wherein the plurality of instructions, when executed by the processor, cause the processor to:
based on the third drawing, determine if any of the draw lottery tickets for that single play of the draw lottery game wins the secondary award associated with the third progressive jackpot award, and
if one of the draw lottery tickets wins the secondary award, cause that secondary award to be available to be provided to a holder of that winning draw lottery ticket upon redemption of that winning draw lottery ticket.
